(19) United States
(12) Patent Application Publication
(10) Pub. No.: US 2008/0097999 A1
(43) Pub. Date: Apr. 24, 2008

(54) Dynamic creation of information sharing social networks

(76) Inventor: Tim Horan, Raleigh, NC (US)

Correspondence Address: John L. Sotomayor, 106 Spring Needle Ct., Cary, NC, 27513, US

(21) Appl. No.: 11/544,862

(22) Filed: Oct. 10, 2006

(51) Int. Cl. G06F 17/30

(52) U.S. Cl. 707/10

(57) ABSTRACT

A system and method for creating and using a searchable and browsable directory of verified, network connected and geo-coded users, listing members according to their proximity to each other and according to the longitude and latitude coordinates of each user. By making the member directory accessible to users dynamically the system eases the connection and interaction of neighbors and members of the same physical community.

### TECHNICAL FIELD

The present invention is directed to the creation, operation, maintenance and administration of a process for sharing information among members of a community. The membership is verified through an address verification process such that the community may control the dissemination of information to those most concerned and those that may make the most use of the information available to the community, regardless of the size of the verified community.

### BACKGROUND OF THE INVENTION

Social networks of users who are connected through a computer-based World Wide Web interface are well known. U.S. Pat. No. 7,069,308 describes the online connection of users based upon relationships between the users within the social networks built up of commonly held interests, or the desire to share information with other users on the social network. Current neighborhood or community networks allow residents of the network neighborhood or community to communicate information about related topics of interest with other members of the community. By using an online network or mail list service that is accessible to residents in the community, users are able to easily and quickly share information with other participating members of their community about topics of interest or concern to the community at large. These topics include related news and information that is deemed important to the membership of the social network.

The present social networks rely on a network administrator to grant access rights to members of the community to ensure that the membership has secure access to the network while preventing people from outside the defined community from accessing the network and the related membership and member information. This approach to network access management ensures a higher level of security, but reduces the utility and scalability of the network by limiting the type of information, the number of members, and the amount of information and information sources that users of the network can access. Due to the restrictive nature of the security implemented, members can only access information available from the community that the social network serves.

Current social network software products and online social networks are universal platforms, especially when compared to neighborhood networks. A typical social network connects people from any location and according to specific demographic or special interest sets, such as teens, college students, business users, music lovers, those interesting in dating, photography users, and even politics. Members of a typical social network fill out member profile data sheets which detail information about the member and, depending upon the type of interest to which the social network caters, may include information such as name, age, social interests, favorite music, an address, marital status, or work experience. By matching like member profiles, social networks make it extremely easy to connect members who have common interests or common demographic profiles to help them meet other members with whom they appear to have much in common. These meetings facilitate communication between members, allowing them to share, publish, and distribute information and media objects such as text, image, audio and video files about each other or about the common topics of interest related to that particular social network.

However, a need exists to assist users in building communities in which the members are bound not only by common interests, but in which they are also geographically compatible. Current social networks do not authenticate the location or the identities of the members of each community. U.S. Published Patent Application 2006143068 goes so far as to state that physical address verification is impractical. The social network relies upon the members providing truthful information upon the submitted member profile sheets. As a result, the social network service providers are unable to prevent dishonest users from creating false member profiles in order to connect with other members under false pretenses and/or with predatory intentions. Therefore, the need also exists for a system and method for authenticating members such that cross verification of the member identity and geographic location may be accomplished.

### SUMMARY OF THE INVENTION

This invention is a system and method for the incorporation of an address verification and geo-coding process to authenticate a member of an online social network or other online community building system in order to enable the dynamic creation of social networks according to each member's verified physical address. In addition, the invention enables users to publish information and distribute objects, manage online communications, and manage associated sharing and access rights between users of the network.

A searchable and browsable directory of address verified and geo-coded users lists members according to their proximity to each other and according to the longitude and latitude coordinates of each user's verified address. By making the member directory accessible to users and dynamically matching members according to their physical address location, the invention provides a simple and systematic means for neighbors and members of the same physical communities to connect into a geographically based social network and interact with one another. This innovative system provides ease of use and universal access for any person, neighborhood or community in establishing secure and verifiable neighborhood and community networks.

### BRIEF DESCRIPTION OF THE DRAWINGS

FIG. 1: Social Network Creation and Operation process

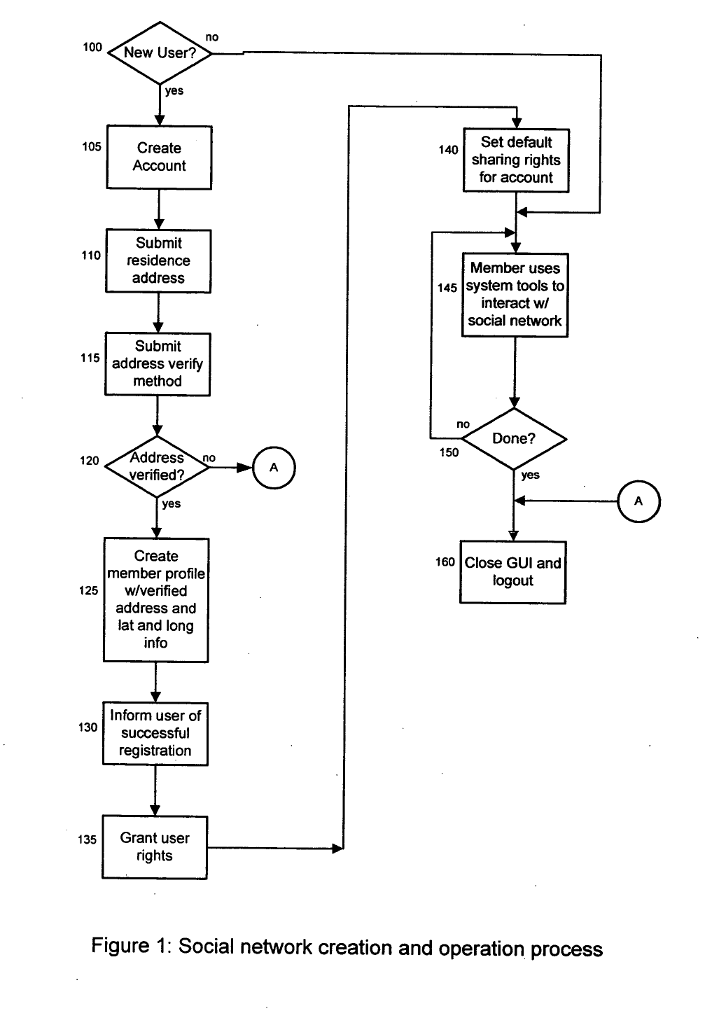

FIG. 2: Social Network System diagram

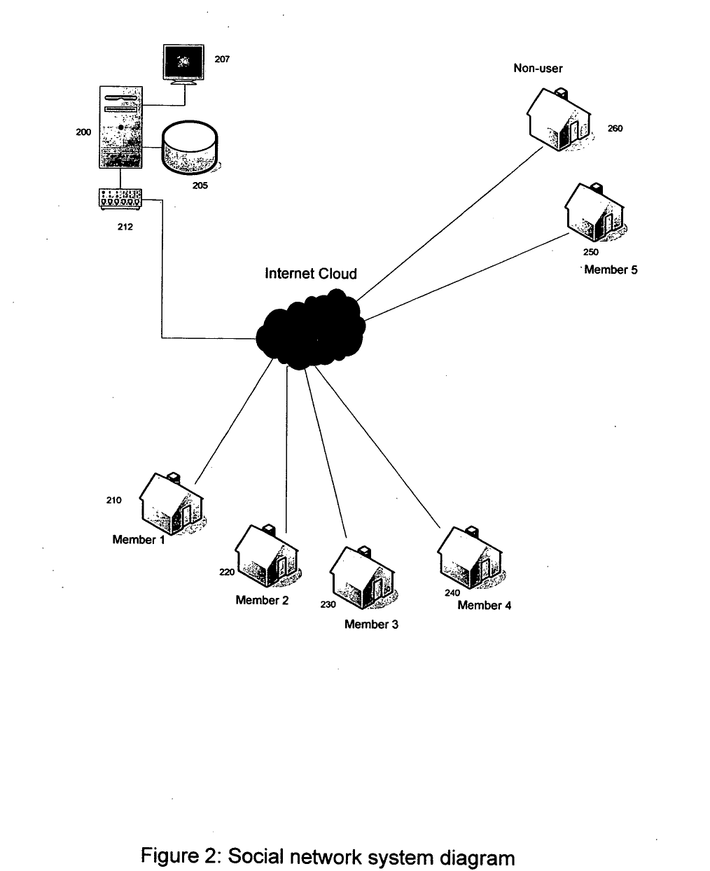

### DETAILED DESCRIPTION OF THE INVENTION

The invention is a system and method for enabling users of the system to have the opportunity to become members in a social networking system. In a preferred embodiment of the invention, the system provides the means for the dynamic creation of one or more social networks based upon the verified physical address of residence for each member (210-250) added to the one or more social networks. In addition, the system provides for the maintenance and administration of the social network communication and information sharing between members. Members may manage their own accounts on the social network server 200, managing information sharing, online communication and associated sharing and data access rights between members. These processes are accessed and updated by members according to each member's confirmed and verified physical address of residence (210-250), as well as any personal relationship designations as made by each member.

The inventive system comprises a central server 200, which is a computer processor with sufficient memory to store all of the operating software modules to provide each service offering to each address verified member. The central server also comprises a data base module 205 that receives and stores all of the information each verified member (210-250) provides to the social network management software module. The social network management software module displays a web-based user interface that is displayable on all commonly used web browsers to each member upon connection to the social network server 200. The social network management software module is also the primary interface between the user interface software based display and the data base software module 205. The system also comprises a display device 207 for use in the maintenance and administration of the system software modules, and network communication channels 212 used to attach to the Internet and thus connect to all members of each social network administered by the system.

In a preferred embodiment, a user may connect to the social network Web page and, by entering their login id and password, enter and use the social network functions and capabilities. However, a user who is not currently a member but wishes to become a member of a physical address verified social network would begin the process by creating a member account on the system 105. In the preferred embodiment, the user would be applying for membership in a social network that will, as an example, be referred to as an account with the Beecoz social network. Beecoz is simply the name for one of many social networks that can be administered by the system, wherein each social network verifies the physical address of each member of the social network 120, and in no way limits the instant invention to the creation and administration of only one social network. Beecoz is used simply as a convenience in naming the social network described heretofore in the preferred embodiment.

In the preferred embodiment, to become a member of the Beecoz social network, a user connects to the social network management software module through an internet connection 212 by opening the Beecoz social network Web page and indicating a desire to open a Beecoz account by clicking on the appropriate icon on the Beecoz web page. The user is provided with a membership application screen. The prospective member fills in the information required in the membership application screen, including the physical address of the member's residence 110.

The user desiring membership is also requested to provide a means for verifying their physical address 115. In the preferred embodiment, the Beecoz membership application may ask for one of three or more means for verifying the physical address 115. One means for address verification would be to provide the server with a valid credit card number that has the same billing address as the address provided by the prospective member. A second means may be to provide the user with a code sent in the mail to the user at the physical address the prospective member has entered in the membership application which the user may submit to the Beecoz server upon receipt in order to complete the address verification step 120. A third means is the use of a third party service provider, such as a gas bill, cable bill, newspaper bill, or other provider, that has already verified the user's home address and which the Beecoz server would then confirm with the third party provider to complete the address verification step 120. In addition, other approved address verification means can be identified in the future to provide users with additional flexibility in completing the address verification step 120 with the Beecoz social network management software module.

The user submits the membership application that includes the means for address verification that the prospective member has chosen to provide 115. In the preferred embodiment, the Beecoz social network management software module would then confirm the physical address 120 of the user in accordance with the address verification means chosen by the user.

Upon the confirmation of successful address verification 120, the Beecoz social network management software module creates a member profile 125 as a directory listing that contains all information submitted by the new member on the membership application. This profile is a default information set that may include, besides physical address, information items such as the name, phone number, and interest information. The default information set in the member profile also contains the latitude and longitude coordinates for the verified physical address of the member's residence 125.

In the preferred embodiment, the Beecoz social network management software module now adds the member profile directory listing to a universal directory of address verified users. This universal directory is organized by geographic location according to the latitude and longitude coordinates for the member's verified physical address that is contained in the membership profile. Upon the addition of the member's profile to the universal directory, the user is notified that they are new members of the Beecoz social network 130.

In addition, the Beecoz social network management software module may connect to existing directory services providers to obtain data listings, on a revenue sharing, licensed, or purchase basis, for individuals, such as neighbors in a neighborhood, merchants, or others, who are geographically very close to the new, or newly logged in, member. The administrator of the social network system establishes a definition of geographic proximity to a new, or newly logged in member, and may pre-set this definition within the social network management software module to include a street, neighborhood, or any other geographic area definition that may be determined to be close geographic proximity. The new, or newly logged in, member may then be provided with an option to request invitations be sent to these geographically close individuals inviting them to join the social network service. When these invited individuals become address verified members, the listing obtained from the existing directory services provider may be replaced with the data from the member listing created by the social network management software module.

As a new member in the Beecoz social network, each member is assigned a set of default user rights 135 and sharing rights 140 that provides access control to each member for the information contained in their member account. With these rights, for example, a member may allow or prevent other users from viewing their member profile or directory listing, sending invitations to join any social network in which they hold membership, sending electronic messages within the social network, or utilizing any other communication and networking functions presented to the membership. The default sharing rights 140 provided to each member are established according to defined geographic criteria based upon the member relationships and the distance of their physical addresses from one another. In this fashion, the Beecoz social network may take advantage of the proximity of groups of members to introduce information of interest to members within defined geographic proximity, such as a neighborhood, or of interest to larger geographic memberships such as a town, county, or any other defined geographical area. Members may also take advantage of the known geographic proximity of groups of other members to target informational items that are of interest only to such groups as neighborhoods, or school attendance areas, among others.

In the preferred embodiment, the Beecoz social network management software module may provide the ability for registered members, with a physical address verification step completed 120, a facility to build their personal social network connections to other address verified members who may be registered in the social network. The Beecoz social network management software module may provide registered members a listing of other members within the social network that are geographically close to an individual registered member. To receive this listing, the registered member may change the default setting for the sharing rights criteria to a setting that can provide such a listing. Additionally, the Administrator for the Beecoz social network may provide an initial sharing rights 140 setting that can automatically provide each newly registered member with a listing of all geographically nearby registered members upon completion of the address verification activity. In this manner, the Beecoz social network management software module may stimulate the swift and seamless generation of geographically compatible member communities.

In the preferred embodiment, after the Beecoz social network provides a listing of geographically compatible members to any given existing member, the member may chose to add a person from the listing to their personal group of member connections. To facilitate this process, in this embodiment the Beecoz social network management software module may prompt a first member to add a selected second member from said listing as the second member becomes known to the social network management software module 145. The first member may then categorize the selected second member into one of a plurality of default categories defined by the Beecoz social network management software module such as neighbor, friend, family, or other defined category. The first member may also choose to place the selected second member into a category that has been previously defined by said first member such as neighborhood association, PTA organization, or any other category the first member may deem appropriate to facilitate future communication and interaction. Upon the selection of a second member from the listing of geographically compatible members by said first member, the selected second member may be queried by the Beecoz social network management software module as to the request to be added to said first member's personalized social grouping. If the selected second member gives their permission, the Beecoz social network management software module may then add the selected second member to said first member's personalized social grouping. Simultaneously, said first member may be added to the personalized social grouping of the selected second member upon the granting of permission to be so added from said first member.

Within the Beecoz social network, in the preferred embodiment, each discrete item of information is assigned a sharing right 140. This sharing right assignment is used to enable or prevent the sharing of information or data objects with the membership within the Beecoz social network. Items with defined sharing rights may include text files, audio files, video files, directory listings, metadata, or any other user or system generated content.

In the preferred embodiment, sharing rights are consulted to determine which members within any individual member's social network are granted or denied access to content generated or held by said individual member. Content may be shared with an individual member's personal social connections, with a broader defined community based upon geographic location such as a zip code, city, county, or other defined geographic area that may be based upon distance from an individual's personal address, or content may be shared based upon a predefined categorization of members such as personal connections or other distinct categorization 145. A member may set their own sharing rules to share or not share discreet information or data objects each member has added to their own member profile or directory listing 145. A member may also post information to be shared with other members of their personal network, other members of a larger social network, or with other members in the member directory listing at large 145.

While this invention has been particularly shown and described with reference to preferred embodiments thereof, it will be understood by those skilled in the art that various changes in form and details may be made therein without departing from the spirit and scope of the invention as defined by the appended claims.

I claim:

1. A system for the creation, administration, and maintenance of a network of members sharing common parameters and connected by said common parameters comprising:
a computer server;
a display monitor;
a software module configured to display a graphical user interface;
at least one network communication channel for allowing one or more members to communicate together using said computer server and said graphical user interface;
a memory storage element resident within said computer server;
a management and maintenance software module stored within the memory storage element and configured to communicate with said members;
an address verification software module resident within said computer server configured to accept physical address information from any one of said members and means for providing verification of said physical address information;
a database configuration and maintenance software module resident within said server and configured to import information from said communication channel, format said information for storage, and store said formatted information into said memory storage element;
wherein the system software and components are operable to build and manage a social network further comprising members with verified physical address information.

2. A system according to claim 1 for the creation, administration, and maintenance of a network of members sharing common parameters and connected by said common parameters further comprising:
said graphical user interface provides means for communicating with members using any of a plurality of commonly available Web browsers.

3. A system according to claim 1 for the creation, administration, and maintenance of a network of members sharing common parameters and connected by said common parameters further comprising:
said communication channel comprises an Internet connection with each of said members.

4. A system according to claim 1 for the creation, administration, and maintenance of a network of members sharing common parameters and connected by said common parameters further comprising:
said address verification software module collects a plurality of discrete information items from each prospective member for storage in said memory storage element;
wherein one of said discrete information items is a physical address of the residence of said prospective member.

5. A system according to claim 1 for the creation, administration, and maintenance of a network of members sharing common parameters and connected by said common parameters further comprising:
said database configuration and maintenance software module stores the latitude and longitude parameters for each verified physical address within a member profile created for each member.

6. A system according to claim 5 for the creation, administration, and maintenance of a network of members sharing common parameters and connected by said common parameters further comprising:
said management and maintenance software module uses said stored latitude and longitude parameters to create and maintain a directory listing of members according to geographic proximity to one another;
said management and maintenance software module uses said stored latitude and longitude parameters and directory information obtained from existing directory services providers to create and maintain a directory listing of all listed individuals according to geographic proximity to one another;
wherein the directory listing may be used to create and maintain social networks of members and other individuals that are within previously specified proximity to one another.

7. A method for the creation, administration, and maintenance of a network of members sharing common parameters and connected by said common parameters, the method steps comprising:
a) communicating with a computer server to establish a membership account;
b) entering data items into a Web-based graphical user interface display screen, including the member's physical residence address;
c) selecting a means for verifying the member's physical residence address;
d) the computer server utilizing said means to verify the member's physical residence address and issue permission for the member to join the social network;
e) using a social network management and administration software module to establish and maintain member contact lists to build social networks of varying granularity;
f) said social network management and administration software module providing access rights for members within each social network structure;
g) collecting database information from third-party directory listing services to provide to each member a listing of all individuals located within a pre-defined geographical area of each member;
h) wherein said social networks are used by said members to contact other members and individuals that may have similar or common interests and may be physically located within an acceptable geographic proximity to one another.

8. A method according to claim 7 for the creation, administration, and maintenance of a network of members sharing common parameters and connected by said common parameters, the method steps further comprising: wherein members are provided means for designating other members within the social network system to be added to said first member's social network.

9. A method according to claim 7 for the creation, administration, and maintenance of a network of members sharing common parameters and connected by said common parameters, the method steps further comprising:
means for predefining and applying default sharing rights for each piece of information entered into a member profile for each member;
wherein each sharing right is attached to said piece of entered information and is utilized to determine access to each piece of information by any and all members.

10. A method according to claim 7 for the creation, administration, and maintenance of a network of members sharing common parameters and connected by said common parameters, the method steps further comprising:
means for each member to define and apply sharing rights for each piece of information entered into said member's profile;
wherein said sharing rights may be used to create and maintain a member's personal social network based upon geographic proximity and said sharing rights.

11. A software program product embedded within a magnetic memory for the creation, administration, and maintenance of a network of members sharing common parameters and connected by said common parameters, comprising:
a) software means for establishing communication with a computer server to establish a membership account;
b) software means for entering data items into a Web-based graphical user interface display screen, including the member's physical residence address;
c) software means for selecting a verification method for verifying the member's physical residence address;
d) the computer server utilizing said software means to verify the member's physical residence address and issue permission for the member to join the social network;
e) using a social network management and administration software module to establish and maintain member contact lists to build social networks of varying granularity;
f) said social network management and administration software module providing access rights for members within each social network structure;
g) wherein said software created social networks are used by said members to contact other members that may have similar or common interests and may be physically located within an acceptable geographic proximity to one another.
